(19) United States
(12) Patent Application Publication
(10) Pub. No.: US 2003/0190167 A1
(43) Pub. Date: Oct. 9, 2003

(54) All-optical regenerator for wavelength-division multiplexed signals

(76) Inventors: Jean-Claude Simon, Louannec (FR); Bertrand Lambert, Lannion (FR); Slimane Loualiche, Cesson Sevigne (FR); Bernard Sermage, Meudon (FR); David Pureur, Perros-Guirec (FR)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/362,478

(22) PCT Filed: Aug. 28, 2001
(86) PCT No.: PCT/FR01/02679

(30) Foreign Application Priority Data
Aug. 29, 2000 (FR) 00 11048

(51) Int. Cl. H04J 14/02

(52) U.S. Cl. 398/97; 398/79

(57) ABSTRACT

The present invention provides a regenerator device for wavelength division multiplexed optical signals designed to regenerate the N channels of a multiplex simultaneously, the device being characterized in that it comprises at least one regenerator component (112, 152) suitable for coupling the inlet signal with a multiplex of N optical carriers, the regenerator component (112, 152) being constituted by a material presenting a spectrum line with non-uniform broadening so that there is no interaction between the various channels involved within the component.

The present invention relates to the field of optical fiber communication, and more precisely to the field of signal regeneration for such communication.

The person skilled in the art knows that in-line regeneration of signals propagating in optical fiber communication devices using wavelength division multiplexing (WDM) ought to enable the capacity of such devices to be increased considerably. At present, equipment manufacturers and telecommunications operators are very enthusiastic about this topic.

There exist three known types of signal regeneration:

A first type “1R”: the amplitude of the signal is merely amplified, without any other processing.

A second type “2R”: the signal is amplified and reshaped (noise elimination, partial or total restoration of amplitude and/or spectrum), without resynchronization.

A third type “3R”: in addition to the preceding operations, the time jitter of the pulses is eliminated (the signal is synchronous at the clock frequency).

Regenerators of the first type present the drawback of also amplifying defects in the signal (noise, jitter, spectrum deformation).

In the description below, attention is given only to regeneration of the 2R type or of the 3R type.

There exist two main approaches for regenerating optical signals: opto-electronic regeneration and “all-optical” regeneration.

In the first case, the signal is processed electronically after being detected, and the electronic signal is regenerated (noise is removed, and in general the signal is resynchronized), after which it needs to be transferred onto an optical carrier, either by directly modulating the current driving a laser, or by means of an electro-optical modulator. That technique is very effective, but it suffers from the drawback of being particularly complex and expensive for signals that are modulated at high rates (greater than or equal to 2.5 gigabits per second (Gbit/s)). In addition, presently-available devices are not in any way transparent to data rate.

In the second case, signal processing, including amplification, is obtained by purely optical means, using various non-linear effects.

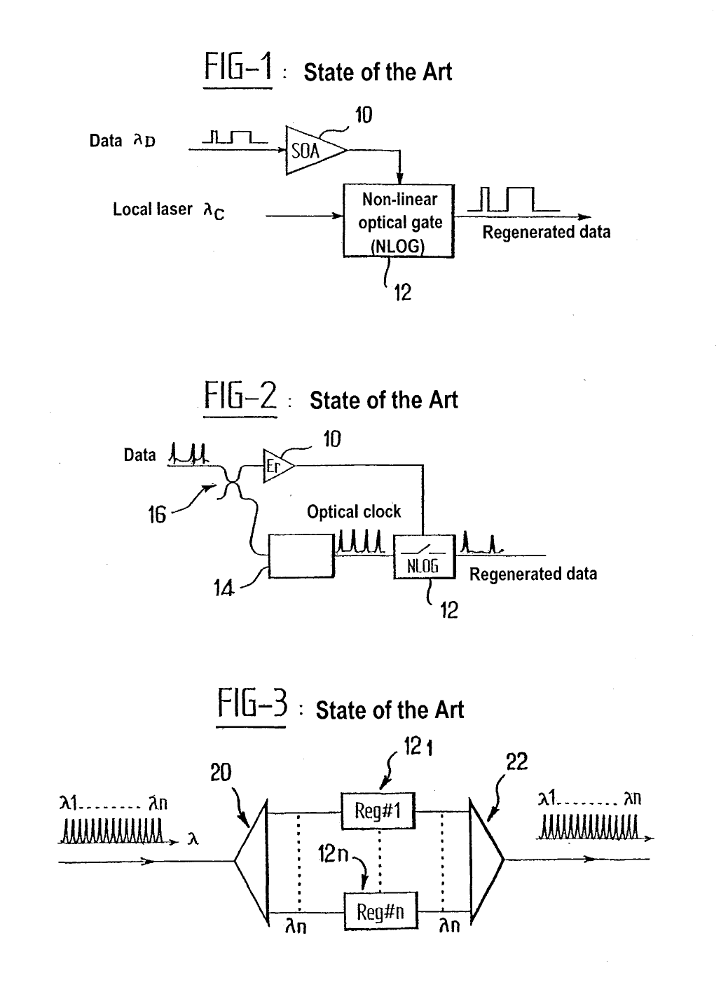

FIG. 1 is an outline diagram of a known all-optical regenerator of the 2R type. The optical inlet signal corresponding to data λ_{D} is amplified in an amplifier 10 and is reshaped, without being resynchronized: the power of the signal to be regenerated modulates in non-linear manner the power of a pure optical carrier (of wavelength λ_{C}, e.g. coming from a local laser) that is noise-free, with this being done by means of a gate component 12 whose transmission factor depends in non-linear manner on the incident light power. The non-linear response of this gate 12 is adjusted so as to enable the signal to be reshaped and so as to eliminate part of the noise.

FIG. 2 is an outline diagram of a known all-optical regenerator of the 3R type. In this case, as shown in FIG. 2, the signal leaving the regenerator is also resynchronized, i.e. time fluctuations in the positions of its pulses have been removed. To do this, it is necessary to recover the clock frequency of the incident signal (e.g. by processing performed in a module 14 on signal that is taken from the inlet by means of a coupler 16), with a local optical clock being created on the basis thereof, and then remodulated in the same manner as in the “2R” case (modulation by the inlet signal as amplified at 10 and using a non-linear optical gate 12). This more-complex technique can be necessary if the time jitter in signals becomes unacceptable, for example in optical transmission devices operating at very high data rates (about 10 Gbit/s) and over long ranges (>2000 kilometers (km)).

Various types of regenerator have been proposed in the literature that comprise an all-optical element acting under the effect of an optical signal, such as an opto-optical gate whose transmission varies in non-linear manner as a function of the intensity of said signal. A summary of the state of the art on this topic can be found in the reference [J. C. Simon et al., “All-optical regeneration techniques”, ECOC '99, Nice, Sep. 26-30, 1999]. So far as the inventors of the present invention are aware, in order to regenerate a set N of wavelength division multiplexed channels, it has, until now, always been essential to use as many non-linear effect opto-optical gates 12 as there are channels in the wavelength division multiplex, and that this applies regardless of the effect used, which may be in particular:

for opto-optical gates based on saturated resonant interaction:

i) cross-absorption modulation (XAM); or

ii) cross-gain modulation (XGM); or

iii) cross-phase modulation (XPM);

for opto-optical gates based on non-resonant interaction, such as the optical Kerr effect in an optical fiber of silica glass (or other material), cross-phase modulation.

The structure of a prior art regenerator can thus be as summarized in FIG. 3: each multiplex channel is separated by means of a demultiplexer 20 and is then processed by a per-channel regenerator device 12₁, . . . , 12ᵢ, . . . to 12ₙ, and then the channels are remultiplexed in a multiplexer 22.

An object of the present invention is to provide a novel optical signal regenerator device that presents performance better than that of previously known devices.

In the context of the present invention this is achieved by a device designed to regenerate the N channels of a multiplex simultaneously, the device being characterized in that it comprises at least one regenerator component suitable for coupling the inlet signal with a multiplex of N optical carriers, the regenerator component being constituted by a material presenting a spectrum line with non-uniform broadening so that there is no interaction between the various channels involved within the component.

In the context of the present invention, the term “coupling” is used to mean non-linear transfer of a signal onto a multiplex.

According to an advantageous characteristic of the present invention, the device is designed to regenerate the N wavelength channels λᵢ of a multiplex simultaneously and is characterized in that it comprises:

a first regenerator component suitable for coupling the inlet signal with a multiplex of N optical carriers of wavelengths λ′ᵢ; and

a second regenerator component suitable for coupling the multiplex as regenerated for a first time on the comb of wavelengths λ′ᵢ and present at the outlet from the first component, simultaneously with a multiplex of N optical carriers tuned to the comb of wavelengths λᵢ; in which the first and second components are both made of a material presenting a spectrum line with non-uniform broadening so that there is no interaction between the various channels involved with the components.

According to another advantageous characteristic of the invention, a multi-wavelength filter tuned to the multiplex λ′ᵢ is provided between the outlet of the first component and the inlet of the second component.

According to another advantageous characteristic of the invention, a multi-wavelength filter tuned to the wavelengths λᵢ is provided between the outlet of the second component.

According to another advantageous characteristic of the invention, at least one of the multiplexes of N optical carriers is modulated by the recovered clock frequency of the corresponding channel.

Other characteristics, objects, and advantages of the present invention appear on reading the following detailed description given by way of non-limiting example and with reference to the accompanying drawings, in which:

FIGS. 1 to 3, described above, are diagrams showing the state of the art;

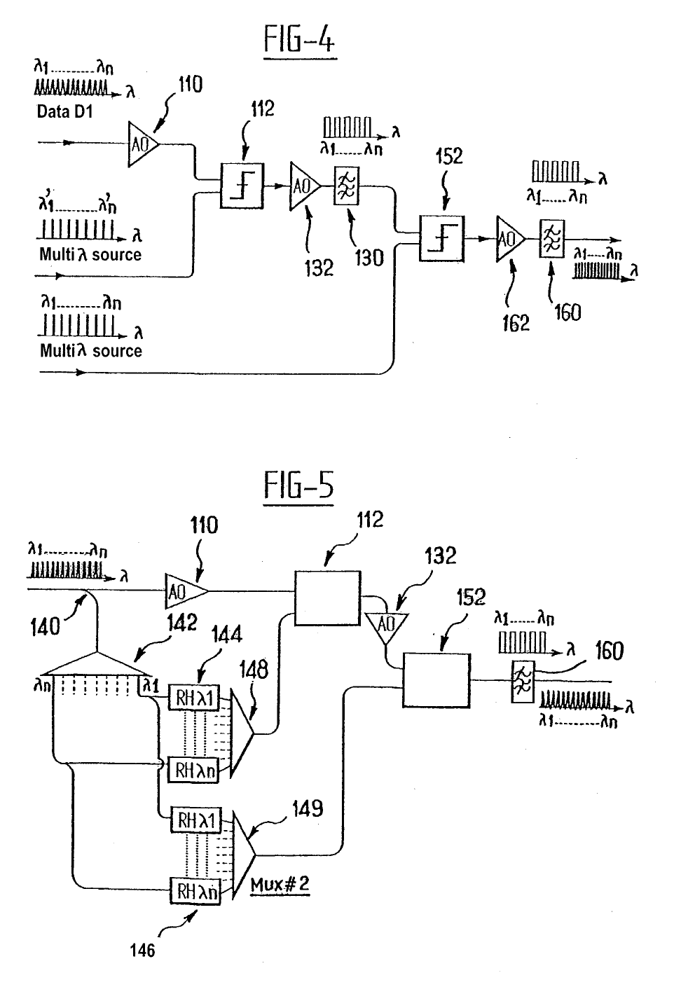

FIG. 4 shows the general configuration of a regenerator in accordance with the present invention; and

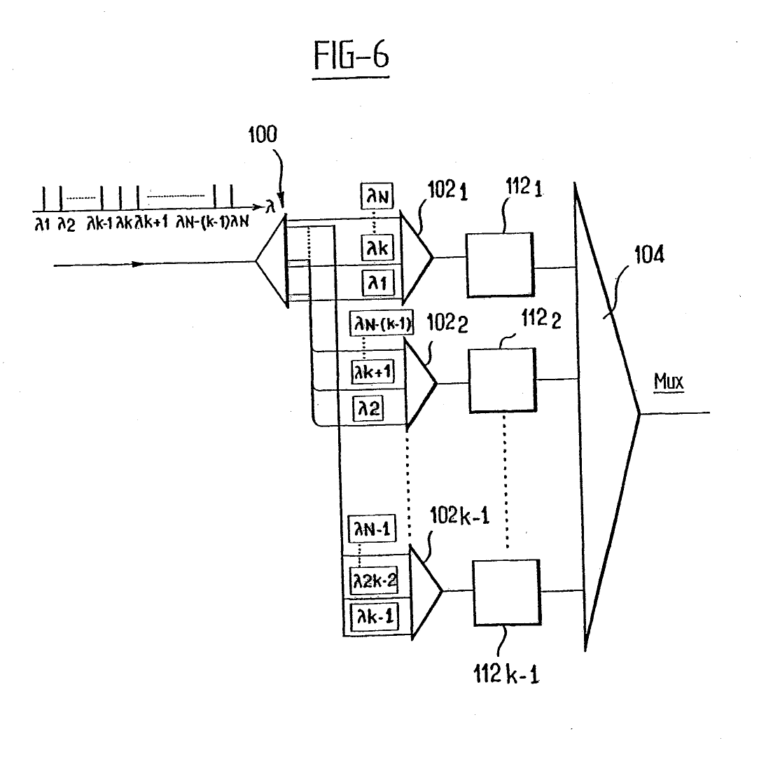

FIGS. 5 and 6 show two variants in accordance with the present invention.

A regenerator in accordance with the present invention is based on the principle of using a single component that performs the non-linear opto-optical gate function that regenerates all of the N channels of the multiplex simultaneously.

A general outline diagram of such a regenerator in accordance with the present invention is given in FIG. 4.

The “2R” and “3R” cases are described separately in greater detail below.

In the general case (shown in FIG. 4), the N channels to be regenerated (data D₁), tuned to a comb of wavelengths λᵢ, are coupled simultaneously in a first regenerator component 112 with a multiplex of N optical carriers at wavelengths λᵢ. In the “2R” case, these optical carriers are not modulated, while, in the “3R” case, each of them is modulated by the clock frequency recovered from the corresponding channel. The inlet data is preferably amplified at 110 prior to being applied to the component 112.

At the outlet from the regenerator component 112, a multi-wavelength filter 130 (e.g. a Fabry-Perot etalon or any other appropriate filter) tuned to the multiplex λ′ᵢ enables any incident data that might have been transmitted to the outlet of the regenerator component 112 to be eliminated.

In order to restore the data to the initial wavelengths and further improve regeneration, the preceding operation is repeated by using a second regenerator component 152 to couple the multiplex as regenerated a first time on the comb of wavelengths λ′ᵢ simultaneously with a multiplex of N optical carriers tuned to the wavelength comb λᵢ. These carriers can be unmodulated or modulated at the clock frequency of the corresponding channel, as in the preceding case.

A filter 160 tuned to the wavelengths λᵢ is placed at the outlet from the second component 152 so as to recover the regenerated data only.

Furthermore, and preferably, as can be seen in FIG. 4, the signal is amplified at 132 prior to being applied to the filter 130, and at 162 prior to being applied to the filter 160. In FIG. 4, references 110, 132, and 162 represent optical amplifiers.

When the level of regeneration is insufficient at the outlet from the filter 160 after using two regenerator blocks 112, 152 in cascade as shown in FIG. 4, it is possible to extend the configuration to X regenerator blocks in cascade, where X is greater than 2.

In the invention, the data and the non-modulated carriers are preferably transmitted in co-propagating manner through the regenerator components 112 and 152.

The inventors have shown that under such circumstances, i.e. implying two changes of wavelength (when it is desired to process signals without putting constraints on the polarization of the incident signal), the maximum rate at which information can be processed is limited solely by the time required for the non-linearity of the regenerator component to return to equilibrium.

Nevertheless, in a variant, the inlet data signal and the multiplexes of N optical carriers can be transmitted in contra-propagating manner through the regenerator component 112 or 152.

Under such circumstances, it is preferable to place a circulator at the inlet to the regenerator component beside the data signal inlet so as to enable the regenerated signal to be picked up, and to place an isolator at the outlet so as to block the data signal. Furthermore, the wavelengths of the data signals and the corresponding wavelengths of the locally-generated carrier multiplex can be identical.

In the invention, each of the regenerator components 112 and 152 must be made of a material whose optical properties (absorption or amplification or refractive index or polarization, etc.) are capable of being modified by an optical signal at a given wavelength without that modification having repercussions on some other wavelength corresponding to an adjacent channel. Thus, in the invention, the components 112 and 152 are made of a material that presents a spectrum line with non-uniform broadening, i.e. the total fluorescence (or absorption) spectrum line is constituted by a set of uniform spectrum lines that are finer, being of width δλ_{H} spread within the non-uniform spectrum of width δλ_{INH}, and not overlapping. In this manner, the absorption, or gain, or phase modulation induced by a channel situated at a wavelength λᵢ does not disturb the absorption, or the gain, or the phase of another channel of λⱼ providing the wavelength difference Δλ_{C} between these channels is greater than the width of the uniform spectrum line δλ_{H} of the material. There is therefore no interaction between the channels providing the separation Δλ_{C} between the channels is greater than about δλ_{H}. It is thus possible in the invention to process all N WDM channels in a single component 112 or 152, providing the number N is less than or equal to the ratio δλ_{INH}/δλ_{H}.

It is important for the wavelength separation δλ=λᵢ−λ′ᵢ not to be arbitrary. Firstly, it is necessary for this separation to be well below the width of the uniform spectrum line so as to obtain efficient opto-optical modulation (so δλ is less than or equal to δλ_{H}/4), and secondly it is necessary for δλ to be greater than the modulation bandwidth of the signal so as to make it possible to filter the regenerated data effectively (so δλ must be greater than or equal to 2δλ_{info}). Overall, this limits the maximum passband of the signal to be regenerated to about δλ_{H}/8.

Furthermore, it is necessary for the time taken by the non-linearity in the absorption or gain or refractive index of the components 112, 152 to return to equilibrium after being disturbed by a signal impulse to be about as long as or a little shorter than the reciprocal of the clock frequency of the signal. Given the intended field of application, this time lies in the range 10 picoseconds (ps) to 100 ps.

This implies in particular that the width of the uniform spectrum line should be equal at least to about twice the clock frequency of the data to be processed.

By way of example, the components 112 and 152 can be constituted by an absorbing or an amplifying semiconductor light waveguide constituted by quantum islands in the InAs system on an InP substrate [S. Frechengues, doctoral thesis, INSA Rennes, Nov. 27, 1998], or else a glass waveguide including quantum islands of PbS [K. Wundke et al. Applied Physics letters, Vol. 76, No. 1, 2000, pp. 10-21], both of which materials can operate at a wavelength of 1550 nanometers (nm). With both types of material, the non-uniform broadening of the transition spectrum line comes from the varying sizes of the islands.

When separation between channels is less than δλ_{H}/4, as specified above, it is difficult to regenerate correctly all of the channels using the structure described above and shown in FIG. 4, because of problems of cross-talk. It is therefore appropriate to multiply the number of multi-wavelength regenerators operating in parallel to process subsets of channels that are spaced by about δλ_{H}, as specified above. To do this, as shown in FIG. 6, it is possible to separate the data channels using a wavelength demultiplexer 100 and then to recombine channels that are separated by slightly more than δλ_{H} using appropriate multiplexers 102ᵢ, prior to coupling them in respective regenerator components 112ᵢ with the corresponding locally-generated comb of wavelengths. The outlets from the various components 112ᵢ are then grouped together in a multiplexer 104.

FIG. 4 thus represents the most general version of the multi-wavelength regenerator proposed in the context of the present invention and based on two regenerator components.

However, as mentioned above, the device of the present invention need have only one such component.

The components 112, 152 constituted by opto-optical gates based on non-linear material can be implemented in a variety of ways.

For example it is possible to use an opto-optical gate based on a material that presents either saturable absorption, or saturable amplification, without modifying refractive index.

Such a gate can be constituted by two components separated by an optical isolator, a filter, and an attenuator (if necessary). The signal to be regenerated is split into two portions and coupled in parallel into each component, while the locally generated wave (a continuous wave or a wave modulated by the recovered clock) passes through both components in series. This configuration which can be extended to K (K>2) components where necessary, presents the feature of improving the extinction ratio and of reducing amplitude noise on the regenerated data. However, it can invert signal polarity, particularly when the opto-optical gates are constituted by semiconductor optical amplifiers, which then makes it necessary to cascade an even number of such gates in order to conserve the polarity of the incident signal.

In a variant, the data signal is coupled separately into the two regenerator components, while the modulated or unmodulated locally-generated carriers pass through both regenerator components in succession.

The gate can be an opto-optical gate based on a material presenting refractive index modulation induced by the data.

Under such circumstances, the opto-optical gate can be constituted by a two-wave or a multiple-wave interferometer, preferably a traveling wave interferometer as in a two-branch Mach-Zehnder interferometer, where each branch includes a multi-wavelength regenerator component whose refractive index has a characteristic that is spectrally non-uniform in the sense described above.

It is also possible to use gates of different types in a single device.

For a “2R” regenerator, the configuration of the present invention is as described in the general case of FIG. 4. The multiplexes of N optical carriers having wavelengths λᵢ or λ′ᵢ corresponding to a “multi-wavelength source” can be obtained by a set of non-modulated sources produced by appropriate means and coupled into the regenerator components 112 or 152 by appropriate means (N-to-1 couplers or a wavelength-division multiplexer, for example).

For a “3R” regenerator, the circuit preferably has the configuration shown in FIG. 5.

A small fraction of the inlet channel multiplex is taken off by means of a coupler 140 and then applied to a wavelength-division demultiplexer 142. Each outlet from the demultiplexer 142 is split into two paths by suitable means, one being applied to clock recovery means 144 generating a source of short pulses synchronously with the clock frequency of the corresponding channel at the wavelength λ′ᵢ and the other to identical means 146 but emitting at the wavelength λᵢ. Each outlet from the group of clocks at λ′ᵢ is recombined using appropriate means (e.g. a multiplexer 148) within the first multi-wavelength regenerator component 112, into which the main portion of the data multiplex leaving the coupler 140 is coupled (after amplification at 110). The outlet from the multi-wavelength regenerator component 112 is filtered by suitable means (130) so as to allow through the regenerated data on the comb λ′ᵢ (and it is optionally amplified at 132). This data is in turn coupled into the regenerator component 152 together with the clocks tuned to the comb λᵢ (and grouped together in a multiplexer 149, for example). Finally, the regenerated data leaving 152, tuned to the initial comb, is filtered at 160 to eliminate all traces of the data coming from 112 on the comb λ′ᵢ.

In a variant of this 3R regenerator device, the second comb of clocks at the wavelengths λᵢ can merely be replaced by a non-modulated comb of carriers at λᵢ, in particular when the second regenerator component is constituted by an interferometer opto-optical gate operating in push-pull mode [K. Tajima, JPn. J. Appl., Vol. 32, Part 2, Nr 12A (1993), pp. L1746-1749].

In the circuit shown in FIG. 5, it is preferable also to provide delay lines (not shown in FIG. 5 in order to simplify the figure) placed on the paths of the clocks tuned to the comb λ′ᵢ and λᵢ, said delays being selected in such a manner that the information carried by the inlet signal arrives synchronously with the information carried by the clocks, taking account of the delays introduced by the various elements through which these signals pass.

The description above relates to various devices in accordance with the present invention having two regenerators 112, 152 connected in cascade, the first regenerator 112 being offset onto the frequencies of the carriers λ′ᵢ with the second regenerator 152 serving to return the data to the initial wavelengths.

Nevertheless, where appropriate, the device of the present invention need have only a single regenerator operating on each data channel.

The configuration shown in FIG. 6 is an example of such a variant where a single multi-wavelength regenerator component 112 based on saturated absorption in a material whose transition spectrum line presents non-uniform broadening as described above, makes it possible to improve the contrast (ratio of high level over low level in an amplitude-modulated binary digital communications signal) in each channel of the wavelength-division multiplex. The entire multiplex is amplified using an optical amplifier 110 to raise the level of the multiplex to a value that corresponds to the operating point of the non-linear component 112, and then the multiplex is coupled into the multi-wavelength regenerator component 112. Because of the non-linear transmission, the low level is transmitted less than is the high level, thereby improving contrast. Naturally, it is possible to cascade a second component (or indeed N components) if contrast turns out to be insufficient when using only a single component. Nevertheless, the absorption recovery time must under such circumstances be about one-tenth the duration of the pulse to be regenerated so as to avoid excessively deforming the signal. It should be observed that this device does not enable noise to be eliminated from the high level of the signal, unlike the devices described above.

It will be understood that the present invention proposes an all-optical regenerator device for digitally modulated telecommunications signals on an optical fiber, enabling N wavelength-multiplex optical channels (N>2) to be processed simultaneously in a single component, with the total number of regenerator components used being fewer than that which is required by devices in accordance with the state of the art.

Naturally, the present invention is not limited to the particular embodiment described above, but extends to any variant within the spirit of the invention.

1/ A regenerator device for wavelength-division multiplexed optical signals designed to regenerate the N channels of a multiplex simultaneously, the device being characterized in that it comprises at least one regenerator component (112, 152) suitable for coupling the inlet signal with a multiplex of N optical carriers, the regenerator component (112, 152) being constituted by a material presenting a spectrum line with non-uniform broadening so that there is no interaction between the various channels involved within the component.

2/ A device according to claim 1, characterized by the fact that it comprises:
a first regenerator component (112) suitable for coupling the inlet signal with a multiplex of N optical carriers of wavelengths λ40 ᵢ; and
a second regenerator component (152) suitable for coupling the multiplex as regenerated for a first time on the comb of wavelengths λ′ᵢ and present at the outlet from the first component (112), simultaneously with a multiplex of N optical carriers tuned to the comb of wavelengths λᵢ;
in which the first and second components (112, 152) are both made of a material presenting a spectrum line with non-uniform broadening so that there is no interaction between the various channels involved with the components (112, 152).

3/ A device according to claim 1 or claim 2, characterized by the fact that a multi-wavelength filter (160) is provided at the outlet from the regenerator component (112, 152) from which the outlet signal is taken.

4/ A device according to claim 2, characterized by the fact that a multi-wavelength filter (130) tuned to the multiplex λ′ᵢ is provided between the outlet of the first regenerator component (112) and the inlet of the second regenerator component (152).

5/ A device according to claim 3 or claim 4, characterized by the fact that the filter (130, 160) is formed by a Fabry-Perot etalon.

6/ A device according to any one of claims 1 to 5, characterized by the fact that the multiplex applied to the regenerator (112, 152) is a locally generated signal without modulation.

7/ A device according to claim 6, characterized by the fact that the multiplex of N optical carriers applied to the regenerator component (112, 152) is generated by N sources coupled to the regenerator component (112, 152) by an N-to-1 coupler or a multiplexer.

8/ A device according to any one of claims 1 to 5, characterized by the fact that the multiplex of N optical carriers is modulated at the clock frequency of the corresponding inlet channel.

9/ A device according to claim 8, characterized by the fact that it includes both a coupler (140) suitable for taking a fraction of the inlet signal, and clock recovery means (144, 146), respectively suitable for generating a source of pulses synchronous with the clock frequency of the corresponding channel at a wavelength λ′ᵢ, and similar pulses at the wavelength λᵢ.

10/ A device according to claim 8 or claim 9, characterized by the fact that it further comprises delay lines placed on the paths of the clocks and selected in such a manner that the information carried by the inlet signal arrives simultaneously with the information carried by said clocks, taking account of the delays introduced by the various elements through which these signals pass.

11/ A device according to any one of claims 1 to 10, characterized by the fact that it includes an amplifier (110) upstream from the regenerator component (112, 152).

12/ A device according to any one of claims 1 to 11, characterized by the fact that it includes an amplifier (162) downstream from the regenerator component (112, 152).

13/ A device according to any one of claims 1 to 12, taken in combination with claim 2, characterized by the fact that it includes an amplifier (132) between the two regenerator components (112, 152).

14/ A device according to any one of claims 1 to 13, characterized by the fact that the inlet data signal and the multiplexes of N optical carriers are transmitted in co-propagating manner through the regenerator component (112, 152).

15/ A device according to any one of claims 1 to 13, characterized by the fact that the inlet data signal and the multiplexes of N optical carriers are transmitted in contra-propagating manner through the regenerator component (112, 152).

16/ A device according to claim 15, characterized by the fact that a circulator is placed at the inlet of the regenerator component beside the data signal inlet so as to enable the regenerated signal to be recovered, and an isolator is placed at its outlet so as to block the data signal.

17/ A device according to claim 15 or claim 16, characterized by the fact that the wavelengths of the data signals and the corresponding wavelengths of the locally-generated carrier multiplex are identical.

18/ A device according to any one of claims 1 to 17, characterized by the fact that it comprises a cascade of X regenerator units (112, 152) in series, where X is greater than 2.

19/ A device according to any one of claims 1 to 18, characterized by the fact that the material constituting each regenerator (112, 152) presents a total fluorescence (or absorption) spectrum line that is made up of a set of uniform spectrum lines that are finer, that are distributed within a non-uniform spectrum, and that do not overlap.

20/ A device according to any one of claims 1 to 19, characterized by the fact that the wavelength difference δλ_{C} between two channels is greater than the width of the uniform second lines of the material constituting each regenerator (112, 152).

21/ A device according to any one of claims 1 to 20, characterized by the fact that the number N of channels is less than or equal to the ratio δλ_{INH}/δλ_{H}, in which relationship δλ_{INH} represents the width of the non-uniform spectrum and δλ_{H} represents the width of the uniform spectrum lines.

22/ A device according to any one of claims 1 to 21, characterized by the fact that the spacing between the wavelengths λᵢ-λ′ᵢ is less than the uniform spectrum line width.

23/ A device according to claim 22, characterized by the fact that the spacing between the wavelengths λᵢ-λ′ᵢ is less than or equal to δλ_{H}/4, where δλ₄ is the width of a uniform spectrum line.

24/ A device according to any one of claims 1 to 23, characterized by the fact that the spacing between the wavelengths λᵢ-λ′ᵢ is greater than the channel modulation bandwidth.

25/ A device according to claim 24, characterized by the fact that the spacing between the wavelengths λᵢ-λ′ᵢ is greater than twice the channel modulation bandwidth.

26/ A device according to any one of claims 1 to 25, characterized by the fact that the time required for the absorption, gain, or refractive index non-linearity to return to equilibrium in the material constituting the regenerator (112, 152) after being disturbed by a signal pulse is about as long as or is a little shorter than the reciprocal of the clock frequency of the inlet signal.

27/ A device according to any one of claims 1 to 26, characterized by the fact that the uniform spectrum line width of the material constituting the regenerator (112, 125) is greater than or equal to twice the clock frequency of the data to be processed.

28/ A device according to any one of claims 1 to 27, characterized by the fact that the regenerator (112, 152) is constituted by a light guide including quantum islands of various sizes.

29/ A device according to claim 28, characterized by the fact that the regenerator (112, 152) is constituted by an absorbing or amplifying semiconductor light guide constituted by quantum islands in the InAs system on an InP substrate.

30/ A device according to claim 28, characterized by the fact that the regenerator (112, 152) is formed by a glass light guide including PbS quantum islands.

31/ A device according to any one of claims 1 to 30, characterized by the fact that it includes means (100, 102) suitable for grouping together channels that are separated by spacing greater than the width of the uniform spectrum lines of the material constituting a regenerator component (112, 152) prior to applying said channels to a regenerator component (112, 152) .

32/ A device according to claim 31, characterized by the fact that it comprises a plurality of regenerators (112ᵢ) operating in parallel on groups of channels.

33/ A device according to claim 31 or 32, characterized by the fact that the means suitable for grouping the channels together are constituted by a demultiplexer (100) and a multiplexer (102).

34/ A device according to any one of claims 1 to 33, characterized by the fact that a regenerator (112, 152) is formed by an opto-optical gate based on material presenting either saturable absorption, or saturable amplification, without modifying refractive index.

35/ A device according to claim 34, characterized by the fact that the regenerator (112, 152) comprises two components separated by an optical isolator and a filter, or even an attenuator.

36/ A device according to claim 35, characterized by the fact that the data signal is coupled separately into both regenerator components, while the locally-generated carriers, whether modulated or unmodulated, pass through both regenerator components in succession.

37/ A device according to any one of claims 1 to 36, characterized by the fact that the regenerator (112, 152) is formed by an opto-optical gate based on a material presenting refractive index modulation induced by the data.

38/ A device according to claim 37, characterized by the fact that the regenerator (112, 152) is formed by a two-wave or a multiple-wave interferometer.

39/ A device according to any one of claims 1 to 38, characterized by the fact that it includes means (140) suitable for taking a small fraction of the inlet channel multiplexer, a demultiplexer (142) whose outlet is split into two paths: one directed to a clock recovery device generating a short pulse source synchronously with the clock frequency of the corresponding channel at the wavelength λᵢ, the other to an identical device but emitting at the wavelength λᵢ, the two clock multiplexes obtained in this way being coupled respectively into the two regenerator components (112, 152) the first one of which receives the inlet data multiplex, and the second one of which receives the outlet from the first.
